(19) United States
(12) Patent Application Publication
(10) Pub. No.: US 2020/0076007 A1
(43) Pub. Date: Mar. 5, 2020

(54) BATTERY MANAGEMENT SYSTEM

(71) Applicant: Samsung Electronics Co., Ltd., Suwon-si (KR)

(72) Inventors: Jinyong JEON, Yongin-si (KR); YoungJae KIM, Seoul (KR)

(73) Assignee: Samsung Electronics Co., Ltd., Suwon-si (KR)

(21) Appl. No.: 16/249,080

(22) Filed: Jan. 16, 2019

(30) Foreign Application Priority Data
Aug. 28, 2018 (KR) 10-2018-0101023

(51) Int. Cl. H01M 10/42; H01M 10/48; H01M 2/20

(52) U.S. Cl. CPC H01M 10/425; H01M 10/486; H01M 2010/4271; H01M 2/206; H01M 10/482

(57) ABSTRACT

A battery management system includes a first contact member, a second contact member, and a processor. The first contact member is located on one side of a board. The second contact member is located on another side of a board. The processor is configured to collect sensing data of a battery cell through the first contact member and the second contact member. The first contact member and the second contact member are configured to contact a connection element connected to the battery cell.

### CROSS-REFERENCE TO RELATED APPLICATIONS

This application claims the benefit under 35 USC § 119(a) of Korean Patent Application No. 10-2018-0101023, filed on Aug. 28, 2018, in the Korean Intellectual Property Office, the entire disclosure of which is incorporated herein by reference for all purposes.

### BACKGROUND

### 1. Field

The following description relates to a battery management system.

### 2. Description of Related Art

As an example, a typical battery management system may include a voltage sensor, a current sensor, and a temperature sensor, and may also include sensing wires or a wire harness.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a battery management apparatus includes a first contact member, a second contact member, and a processor. The first contact member is located on one side of a board. The second contact member is located on another side of a board. The processor is configured to collect sensing data of a battery cell through the first contact member and the second contact member. The first contact member and the second contact member are configured to contact a connection element connected to the battery cell.

The first contact member may be configured to contact a first connection element connected to a positive electrode of the battery cell, and the second contact member may be configured to contact a second connection element connected to a negative electrode of the battery cell.

The connection element may include a first busbar connected to a positive electrode of the battery cell and a second busbar connected to a negative electrode of the battery cell.

The first contact member may be located adjacent an area corresponding to one of electrodes of the battery cell on the board, and the second contact member may be located adjacent an area corresponding to another one of the electrodes of the battery cell on the board.

The battery management apparatus may further include a temperature sensor configured to sense a temperature of the connection element.

Each of the first contact member and the second contact member may be a biasing member.

The board may be configured to pass-through electrodes and a vent of the battery cell.

In another general aspect, a battery module includes battery management apparatuses and a battery cell corresponding to each of the battery management apparatuses. Each of the battery management cells includes a first contact member located on one side of a board; a second contact member located on another side of a board; and a processor configured to collect sensing data of a corresponding battery cell through the first contact member and the second contact member. The first contact member and the second contact member are configured to contact a connection element connected to the corresponding battery cell.

The first contact member may be configured to contact a first connection element that is electrically connected to a positive electrode of the corresponding battery cell and the second contact member may be configured to contact a second connection element connected to a negative electrode of the corresponding battery cell.

The connection element may include a first busbar connected to a positive electrode of the corresponding battery cell; and a second busbar connected to a negative electrode of the corresponding battery cell.

The first contact member may be located adjacent an area corresponding to one of electrodes of the corresponding battery cell on the board and the second contact member may be located adjacent an area corresponding to another one of the electrodes of the corresponding battery cell on the board.

Each of the battery management apparatuses may further include a temperature sensor configured to sense a temperature of the connection element.

Each of the first contact member and the second contact member may include a biasing member.

The board may be configured to pass-through electrodes and a vent of the battery cell.

In another general aspect, a battery pack includes slave battery management apparatuses, a master battery management apparatus configured to communicate with the slave battery management apparatuses, and a battery cell corresponding to each of the slave battery management apparatuses. Each of the slave battery management cells includes a first contact member located on one side of a board, a second contact member located on another side of a board, and a processor configured to collect sensing data of a corresponding battery cell through the first contact member and the second contact member. The first contact member and the second contact member are configured to contact a connection element connected to the corresponding battery cell.

The first contact member may be configured to contact a first connection element connected to a positive electrode of the corresponding battery cell and the second contact member may be configured to contact a second connection element connected to a negative electrode of the corresponding battery cell.

The connection element may include a first busbar connected to a positive electrode of the corresponding battery cell; and a second busbar connected to a negative electrode of the corresponding battery cell.

The first contact member may be located adjacent an area corresponding to one of electrodes of the corresponding battery cell on the board and the second contact member may be located adjacent an area corresponding to another one of the electrodes of the corresponding battery cell on the board.

Each of the slave battery management apparatuses may further include a temperature sensor configured to sense a temperature of the connection element.

Each of the first contact member and the second contact member may include a biasing member.

Other features and aspects will be apparent from the following detailed description, the drawings, and the claims.

### BRIEF DESCRIPTION OF THE DRAWINGS

FIGS. 1 through 3 illustrate examples of a battery management system.

FIGS. 4 through 5C illustrate examples of a battery management apparatus attached to a battery cell, in a battery management system according to one or more embodiments.

FIGS. 6 and 7 illustrate examples of a battery module of or for a battery management system according to one or more embodiments.

FIGS. 8 and 9 illustrate examples of a battery pack of or for a battery management system according to one or more embodiments.

FIGS. 10 and 11 illustrate examples of a vehicle including or representing a battery management system according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Various modifications may be made to examples. However, it should be understood that these examples are not construed as limited to the illustrated forms and include all changes, equivalents or alternatives within the idea and the technical scope of this disclosure.

The terminology used herein is for the purpose of describing particular examples only and is not intended to be limiting of examples. As used herein, the singular forms are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art and in context of the disclosure of this application. Terms defined in dictionaries generally used should be construed to have meanings matching with contextual meanings in the related art and the disclosure of this application, and are not to be construed as an ideal or excessively formal meaning unless otherwise defined herein.

Regarding the reference numerals assigned to the elements in the drawings, it should be noted that the same elements will be designated by the same reference numerals, wherever possible, even though they are shown in different drawings. Also, in describing of examples, detailed description of well-known related structures or functions will be omitted when it is deemed that such description will cause ambiguous interpretation of the present disclosure.

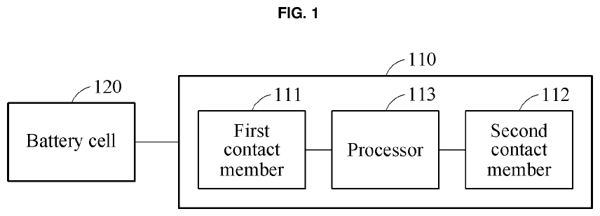

FIGS. 1 through 3 illustrate examples of a battery management system.

Referring to FIG. 1, a battery management system may include any one or both of a battery cell 120 and a battery management apparatus 110 that may include a first contact member 111, a second contact member 112, and a processor 113, as non-limiting examples. Herein, the term battery management system is intended to include examples that include any one or any two or more in combination of the example battery management apparatus 110, the battery cell 120, a battery module, and a battery pack, a slave battery management apparatus, a master battery management apparatus, a vehicle, etc. In an example, the battery management system may include such a battery management apparatus 120 in conductive contact with any of such a battery cell, battery module, or battery pack, which are respectively configured for such conductive contact and for provision of a voltage sensor, a current sensor and/or a temperature sensor to contact the same in conductive contact with the battery management system. Still further, though drawing descriptions subsequent to the description here for FIG. 1 may refer to the respective battery management apparatuses, battery cells, or related contact elements with the same reference numbers as used to describe FIG. 1, and thus may correspond to the same elements and components of FIG. 1, examples also exist where any of the subsequently described battery management apparatuses, battery cells, or related contact elements are not limited by the disclosure with respect to FIG. 1.

Returning to FIG. 1, the first contact member 111 may be located on a side of a board of the battery management apparatus 110. The first contact member 111 is conductive. The first contact member 111 may include at least one biasing member. The biasing member may be, for example, a spring, noting that examples are not limited thereto. Depending on the implementation, the first contact member 111 may include at least one contact pin. The use of the term ‘may’ herein with respect to an example or embodiment, e.g., as to what an example or embodiment may include or implement, means that at least one example or embodiment exists where such a feature is included or implemented while all examples and embodiments are not limited thereto.

The second contact member 112 may be located on another side of the board of the battery management apparatus 110. The second contact member 112 is conductive. The second contact member 112 may include at least one biasing member. Depending on the implementation, the second contact member 112 may include at least one contact pin.

The first contact member 111 and the second contact member 112 contact a connection element that is electrically connected to the battery cell 120. The connection element may include a first connection element and a second connection element. The first connection element may be, for example, a busbar electrically connected to a positive electrode of the battery cell 120. The second connection element may be, for example, another busbar electrically connected to a negative electrode of the battery cell 120. The first contact member 111 contacts the first connection element and the second contact member 112 contacts the second connection element.

The processor 113 is configured to collect sensing data of the battery cell 120 through the first contact member 111 and the second contact member 112. The sensing data includes, for example, either one or both of voltage data and current data of the battery cell 120. When the battery cell 120 outputs or receives a current through the connection element, the current may flow in the first contact member 111 and the second contact member 112 due to their conductivity. Through the first contact member 111 and the second contact member 112, the processor 113 collects the voltage data and/or the current data of the battery cell 120. In this example, a sensing wire, for example, a voltage measuring wire may not be required in the battery management apparatus 110, which simplifies the structure of the battery management apparatus 110.

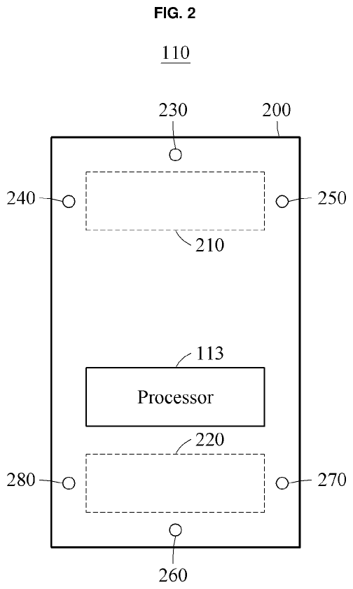

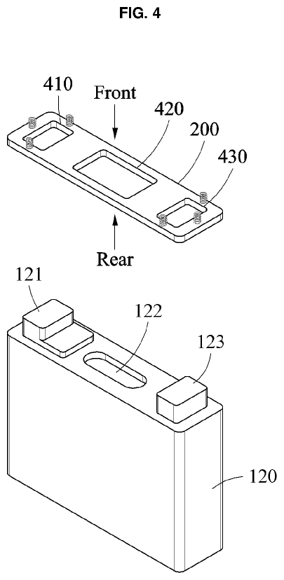

FIG. 2 illustrates an example of a battery management system, and in particular a battery management apparatus 110. Referring to FIG. 2, a board 200 includes a first area 210 corresponding to a positive electrode of a battery cell 120, e.g., of FIG. 1 and which may be included in the battery management system or separate therefrom, and a second area 220 corresponding to a negative electrode of the battery cell 120. As a non-limiting example, each of the first area 210 and the second area 220 may correspond to, for example, a hole as described with reference to FIG. 4.

As non-limiting example, biasing members 230 through 250 may be located around the first area 210, and biasing members 260 through 280 may be located around the second area 220. The biasing members 230 through 250 may correspond to, for example, a first contact member 111, e.g., of FIG. 1, and the biasing members 260 through 280 may correspond to, for example, the second contact member 112, e.g., of FIG. 1.

One of the biasing members 230 through 250 contacts a first connection element that is electrically connected to the positive electrode of the battery cell 120 when coupled to the battery cell 120. One of the biasing members 260 through 280 contacts a second connection element that is electrically connected to the negative electrode of the battery cell 120 when coupled to the battery cell 120.

A processor, e.g., the processor 113 of FIG. 1, may be connected to one of the biasing members 230 through 250 and another one of the biasing members 260 through 280. For example, the processor 113 may be connected to a biasing member contacting the first connection element and connected to another biasing member contacting the second connection element. Through the connection to the first connection element and the second connection element, the processor 113 may measure a voltage of the battery cell 120 using the biasing members connected to the processor 113.

As noted above, though drawing descriptions subsequent to the description of FIG. 1 may refer to the respective battery management apparatuses, battery cells, or related contact elements with the same reference numbers as used to describe FIG. 1, and thus may correspond to the same elements and components of FIG. 1, examples also exist where any of the subsequently described battery management apparatuses, battery cells, or related contact elements, are not limited by the disclosure with respect to FIG. 1. It is also intended to be understood that examples exist where any one or more or all features with respect to one drawing description, e.g., with respect to any or any combination of features described with respect to any or any combination of FIGS. 1-11, are also applicable to any example described herein in all combinations. Accordingly, such clarifications of such cross applicability and such non-limitation between descriptions and similar named and/or similar reference numbered features should be understood hereinafter, and thus such clarifications will not be repeated for brevity purposes.

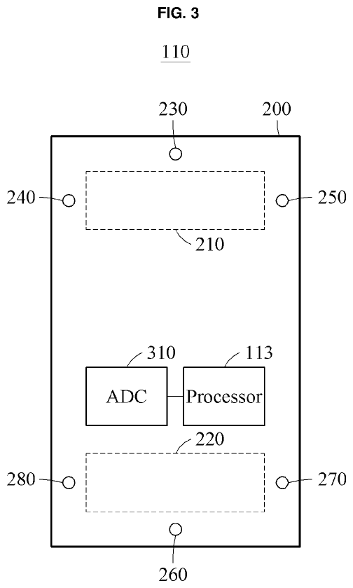

FIG. 3 illustrates an example of a battery management system, and in particular a battery management apparatus 110 of the battery management system. Referring to FIG. 3, an analog to digital converter (ADC) 310 is located on the board 200. In the example of FIG. 3, the ADC 310 is physically separate from the processor 113. However, the processor 113 may also include an ADC as illustrated in FIG. 2.

Referring to FIG. 3, the ADC 310 may be connected to a biasing member contacting a first connection element among the biasing members 230 through 250, and connected to a biasing member contacting a second connection element among the biasing members 260 through 280. The ADC 310 receives an electric signal from the biasing member contacting the first connection element, samples the electric signal, and transmit a sampling result to the processor 113. Also, the ADC 310 receives an electric signal from the biasing member contacting the second connection element, samples the electric signal, and transmit a sampling result to the processor 113.

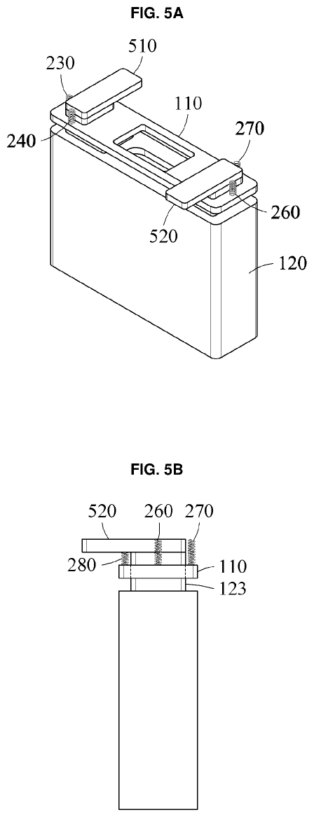

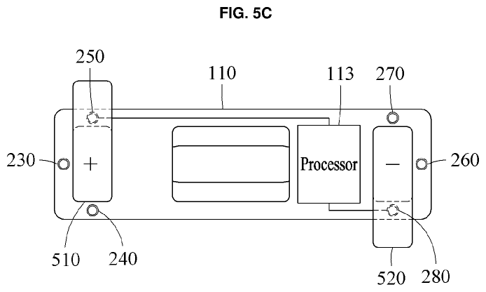

FIGS. 4 through 5C illustrate examples of a battery management apparatus attached to a battery cell. As non-limiting examples, the corresponding battery management systems represented by FIGS. 4 through 5C respectively include one or more of the described battery management apparatuses without the battery cell(s) or one or more of the described the battery management apparatuses and the battery cell(s).

Referring to FIG. 4, a battery management apparatus 110 is attached to a top side of a battery cell 120. The board 200 includes a hole 410 corresponding to a positive electrode portion 121 of the battery cell 120, a hole 420 corresponding to a vent 122, and a hole 430 corresponding to a negative electrode portion 123, so that the battery management apparatus 110 is attached to the top of the battery cell 120. In this example, a rear surface of the battery management apparatus 110 faces the top of the battery cell 120. Depending on the implementation, the battery management apparatus 110 may be attached to a side surface of the battery cell 120. When the battery management apparatus 110 is designed to be attached to the side surface of the battery cell 120, at least one or all of the holes 410 through 430 may not be formed on the board 200.

The biasing members 230 through 250 are located around the hole 410. The biasing members 260 through 280 are located around the hole 430.

One of the biasing members 230 through 250 contacts a first connection element and another one of the biasing members 260 through 280 contacts a second connection element in the process of fixing the first connection element and the second connection element to the battery management apparatus 110.

The biasing members 230 through 250 are configured to connectively contact the first connection element so as to form an electrical connection between the contacting biasing member and the first connection element.

The biasing members 260 through 280 are configured to connectively contact the second connection element so as to form an electrical connection between the contacting biasing member and the second connection element.

The first connection element and the second connection element may be fixed to the battery management apparatus 110 by welding or fastening, for example. In an example, the first connection element and the second connection element may each be a busbar.

FIGS. 5A through 5C illustrates an example of a first connection element and a second connection element fixed to a battery management apparatus 110.

Referring to FIGS. 5A through 5C, a busbar 510 may be fixed to the battery management apparatus 110 so as to be electrically connected to a positive terminal of the battery cell 120. Also, a busbar 520 may be fixed to the battery management apparatus 110 so as to be electrically connected to a negative terminal of the battery cell 120. In this example, the biasing member 250 of the biasing members 230 through 250 contacts the busbar 510 and the biasing member 280 of the biasing members 260 through 280 contacts the busbar 520. Depending on the implementation, the busbar 510 may be fixed to the battery management apparatus 110 such that the biasing member 230 and/or biasing member 240 contacts the busbar 510 biasing member. Also, the busbar 520 may be fixed to the battery management apparatus 110 such that the biasing member 260 and/or the biasing member 270 contacts the busbar 520 biasing member.

In a top view of FIG. 5C, the biasing member 250 is indicated by dashed lines since the biasing member 250 is obscured by the busbar 510. Similarly, the biasing member 280 is also indicated by dashed lines since the biasing member 280 is obscured by the busbar 520.

The processor 113 collects voltage data of the battery cell 120 through the biasing member 250 and the biasing member 280. For example, when current flows in the battery cell 120 via the busbar 510 and the busbar 520, the current may also flow through the biasing member 250 and the biasing member 280. The processor 113 may use the biasing member 250 and the biasing member 280 to measure a voltage between the positive terminal and the negative terminal of the battery cell 120.

Although not shown in FIG. 5, a temperature sensor may be located around the hole 410 or the hole 430. For example, when the temperature sensor is located around the hole 410, the temperature sensor may be connected or configured to contact the busbar 510 in a process of fixing the busbar 510 to the battery management apparatus 110. The temperature sensor measures a temperature of the busbar 510 and transmits a measurement result to the processor 113. The processor 113 estimates or determines a temperature of the battery cell 120 based on the measurement result. The corresponding battery management system includes examples that include the temperature sensor and those where the temperature sensor is distinct from the battery management system.

Although FIGS. 4 through 5C illustrate that the vent 122 is in a shape and a size different from a shape and a size of the hole 420, this is merely an example. The hole 420 may also be in the same shape and size as the vent 122.

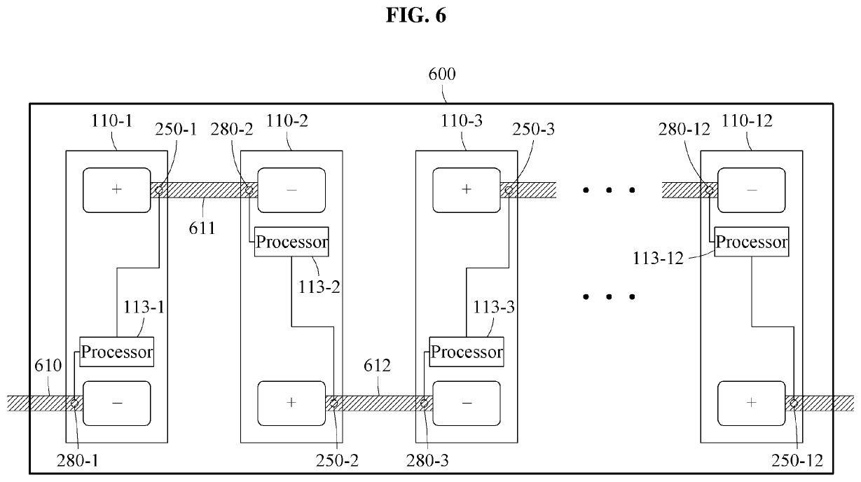

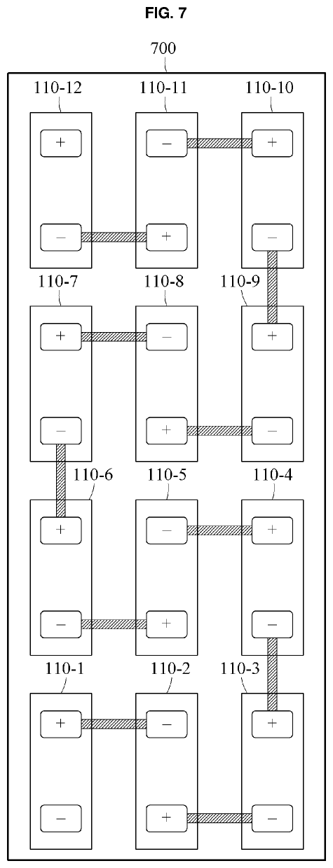

FIGS. 6 and 7 illustrate examples of a battery modules of or for respective battery management systems according to one or more embodiments.

Referring to FIG. 6, a battery module 600 includes battery cells and battery management apparatuses 110-1 through 110-12. The battery management apparatuses 110-1 through 110-12 correspond to the battery cells, respectively.

The battery cells are electrically connected to each other through busbars. As illustrated in FIG. 6, the battery cells are connected in series through the busbars.

In the example of FIG. 6, a negative terminal of a battery cell corresponding to the battery management apparatus 110-1 is electrically connected to a positive terminal of a battery cell in another battery module through a busbar 610. Depending on the implementation, the negative terminal of the corresponding battery cell may be grounded. Also, in the example of FIG. 6, a positive terminal of a battery cell corresponding to the battery management apparatus 110-12 is electrically connected to a lead or a negative terminal of a battery cell in another battery module through a busbar.

A biasing member 250-1 of the battery management apparatus 110-1 contacts a busbar 611. A biasing member 280-1 of the battery management apparatus 110-1 contacts the busbar 610. A processor 113-1 uses the biasing member 250-1 and the biasing member 280-1 to measure a voltage of the corresponding battery cell of the battery management apparatus 110-1.

A biasing member 280-2 of the battery management apparatus 110-2 contacts the busbar 611. A biasing member 250-2 of the battery management apparatus 110-2 contacts a busbar 612. A processor 113-2 uses the biasing member 280-2 and the biasing member 250-2 to measure a voltage of a battery cell corresponding to the battery management apparatus 110-2. Likewise, a processor 113-3 uses a biasing member 280-3 and a biasing member 250-3 to measure a voltage of a battery cell corresponding to the battery management apparatus 110-3, and a processor 113-12 uses a biasing member 280-12 and a biasing member 250-12 to measure a voltage of the corresponding battery cell of the battery management apparatus 110-12.

Although not shown in FIG. 6, each of the battery management apparatuses 110-1 through 110-12 may include a temperature sensor. The temperature sensor of each the battery management apparatuses 110-1 through 110-12 may measure a temperature of a busbar connected or contacting the temperature sensor. For example, the temperature sensor of the battery management apparatus 110-1 may be located around the biasing member 280-1 or the biasing member 250-1 to be connected or to contact the busbar 610 or the busbar 611. The corresponding temperature sensor may measure the temperature of the busbar 610 or the busbar 611 and transmit a measurement result to the processor 113-1. The processor 113-1 estimates or determines a temperature of the battery cell based on the measurement result.

In the battery module 600, the battery cells are arranged physically in parallel but not limited thereto. Battery cells may be arranged in various forms. For example, as illustrated in FIG. 7, battery cells are arranged in a form of a 4×3 matrix in a battery module 700. Since the description of the battery module 600 of FIG. 6 is also applicable to the battery module 700 of FIG. 7, repeated description will be omitted for brevity.

A typical battery module includes wires used for sensing the voltage and the temperature of each battery cell. For example, a battery module including 12 battery cells includes 13 wires for measuring a voltage. Rather, and while such numbered sensing wires are also available, in one or more examples, the aforementioned process of fixing a busbar, a biasing member corresponding to each electrode of a battery cell contacts the busbar and maybe a temperature sensor connected to or contacting the respective busbar, which may result in the example battery modules 600 or 700 not including such typical voltage measuring wires and/or temperature sensing wires including a fewer number of such sensing wires. Such a reduction in the number of sensing wires may simplify and/or reduce manufacturing costs for the battery modules 600 or 700 compared to such typical many sensing or temperature sensor wiring approaches.

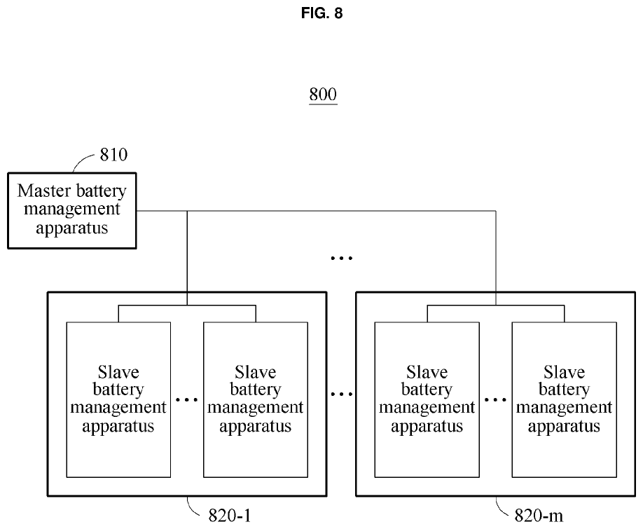

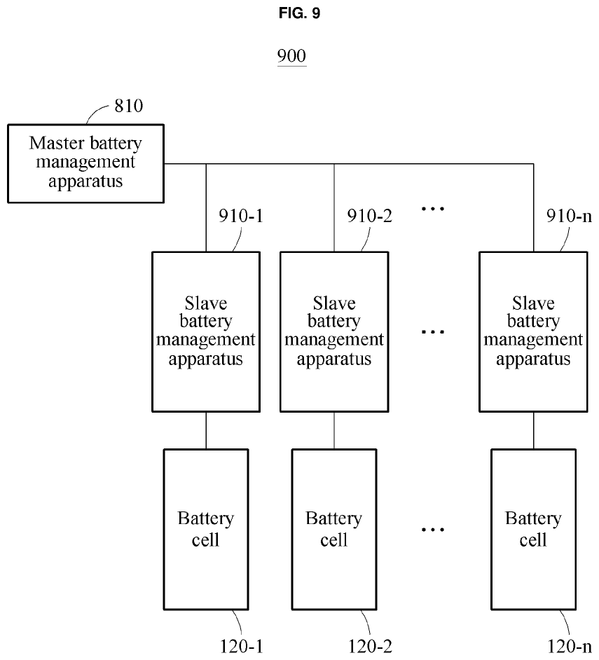

FIGS. 8 and 9 illustrate examples of a battery pack of or for a battery management system according to one or more embodiments.

Referring to FIG. 8, a battery pack 800 includes the master battery management apparatus 810 and battery modules 820-1 through 820-m. Each of the battery modules 820-1 through 820-m may correspond to the battery module 600 or the battery module 700.

Each of the battery modules 820-1 through 820-m includes at least one battery cell and at least one slave battery management apparatus. Here, the slave battery management apparatus corresponds to the battery management apparatus 110.

The battery modules 820-1 through 820-m are electrically connected in series.

The master battery management apparatus 810 communicates with at least one slave battery management apparatus included in each of the battery modules 820-1 through 820-m. For example, the master battery management apparatus 810 transmits a sensing command to each of slave battery management apparatuses. Each of the slave battery management apparatuses senses a corresponding battery cell and transmits sensing data of the corresponding battery cell to the master battery management apparatus 810.

The master battery management apparatus 810 determines state information of each battery cell in the battery pack 800. The state information includes, for example, a state of charge (SOC) and/or a state of health (SOH). For example, the master battery management apparatus 810 determines state information of the corresponding battery cell of each of the slave battery management apparatuses based on the sensing data of the corresponding battery cell of each of the slave battery management apparatuses. Also, the master battery management apparatus 810 determines a maximum value or a minimum value of the state information of the corresponding battery cell of each of the slave battery management apparatuses, to be state information of the battery pack 800.

As noted above, because the description of FIGS. 1 through 7 are also applicable to the description of FIG. 8, repeated description will be omitted for brevity.

In the example of FIG. 8, the battery cells and the slave battery management apparatuses are modularized. Depending on the implements, as illustrated in FIG. 9, a battery pack 900 may be implemented without modularizing slave battery management apparatus 910-1 through 910-n and the battery cells 120-1 through 120-n. Since the description of FIG. 8 is also applicable to the description of FIG. 9, repeated description will be omitted for brevity.

A typical battery pack may include wires used for sensing a temperature and a voltage of each battery cell. For example, a typical battery pack including 96 battery cells may include 104 wires for sensing voltages and 32 wires for sensing temperatures. Alternatively, a typical battery pack may include a wire harness. Rather, and while such numbered sensing wires are also available, in one or more examples the aforementioned process of fixing a busbar, a biasing member corresponding to each electrode of a battery cell contacts the busbar. Also, a temperature sensor may be connected to or contacts the busbar. In this example, the battery module 800 or 900 may not include voltage measuring wires and/or temperature sensing wires. A reduction in the number of sensing wires may, which may simplify and/or reduce manufacturing costs for the battery modules 800 or 900 compared to a typical sensing or temperature sensor wiring approaches may be attained to reduce manufacturing costs for the battery pack 800 or 900.

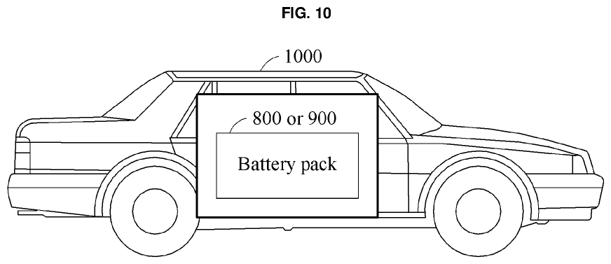

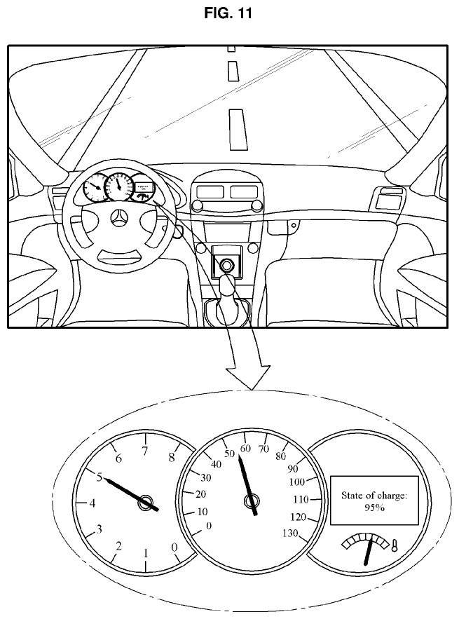

FIGS. 10 and 11 illustrate examples of a vehicle including or representing a battery management system according to one or more embodiments.

Referring to FIG. 10, a vehicle 1000 includes the battery pack 800 or 900. The vehicle 1000 uses the battery pack 800 or 900 as a power source. The vehicle 1000 is, for example, an electric vehicle or a hybrid vehicle.

The master battery management apparatus 810 in the battery pack 800 or 900 determines state information of the battery pack 800 or 900 and transmits the state information to an electronic control unit (ECU) or a vehicle control unit (VCU) of the vehicle 1000. The ECU or the VCU, as illustrated in FIG. 11, controls the display of the state information of the battery pack 800 or 900 on the illustrated display of the vehicle 1000. As represented in FIG. 11, the display includes, for example, a dashboard and/or a head-up display. For example, the referenced dashboard may include an instrument cluster and/or an information console of a center console of the vehicle, or other display configured to be viewable by the driver or other user or viewer.

In an example implementation, the ECU or the VCU is configured to transmit the state information of the battery pack 800 or 900 to a terminal of a user through a wireless communication interface of the vehicle 1000. Through this, the user may check the state information of the battery pack 800 or 900 outside the vehicle 1000.

Since the description of FIGS. 1 through 9 is also applicable to the description of FIGS. 10 and 11, repeated description will be omitted for brevity.

The battery management apparatus 110, the processor 113, and the master battery management apparatus 810 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery management system comprising:
a first contact member located on one side of a board;
a second contact member located on another side of a board; and
a processor configured to collect sensing data of a battery cell through the first contact member and the second contact member,
wherein the first contact member and the second contact member are configured to contact a connection element connected to the battery cell.

2. The system of claim 1, wherein the first contact member is configured to contact a first connection element connected to a positive electrode of the battery cell, and
the second contact member is configured to contact a second connection element connected to a negative electrode of the battery cell.

3. The system of claim 1, wherein the connection element comprises:
a first busbar connected to a positive electrode of the battery cell; and
a second busbar connected to a negative electrode of the battery cell.

4. The system of claim 1, wherein the first contact member is located adjacent an area corresponding to one of electrodes of the battery cell on the board, and
the second contact member is located adjacent an area corresponding to another one of the electrodes of the battery cell on the board.

5. The system of claim 1, further comprising:
a temperature sensor configured to sense a temperature of the connection element.

6. The system of claim 1, wherein each of the first contact member and the second contact member comprises a biasing member.

7. The system of claim 1, wherein the board is configured to pass-through electrodes and a vent of the battery cell.

8. The system of claim 1, further comprising plural processors configured to respectively collect sensing data of a corresponding battery cell, of plural battery cells included in the system, through respective first contact members and respective second contact members.

9. The system of claim 8,
wherein the plural processors are configured in respective slave battery management apparatuses of the battery management system, each slave battery management apparatus being connected to a respective battery module, each including one or more battery cells, of a battery pack, and
wherein the battery management system further comprises a master battery management configured to receive sensing data from one or more or all of the slave battery management apparatuses and configured to determine state information of one or more of the battery cells, battery modules, and the battery pack.

10. The system of claim 9, wherein the battery management system further comprises a display and is configured to output the determined state information to the display.

11. A battery management system comprising:
battery management apparatuses; and
battery cells respectively corresponding to each of the battery management apparatuses,
wherein each of the battery management apparatuses include:
a first contact member located on one side of a board;
a second contact member located on another side of a board; and
a processor configured to collect sensing data of a corresponding battery cell through the first contact member and the second contact member, and
wherein the first contact member and the second contact member are configured to contact a connection element connected to the corresponding battery cell.

12. The battery system of claim 11, wherein the first contact member is configured to contact a first connection element connected to a positive electrode of the corresponding battery cell and
the second contact member is configured to contact a second connection element connected to a negative electrode of the corresponding battery cell.

13. The battery system of claim 8, wherein the connection element comprises:
a first busbar connected to a positive electrode of the corresponding battery cell; and
a second busbar connected to a negative electrode of the corresponding battery cell.

14. The battery system of claim 11, wherein the first contact member is located adjacent an area corresponding to one of electrodes of the corresponding battery cell on the board and
the second contact member is located adjacent an area corresponding to another one of the electrodes of the corresponding battery cell on the board.

15. The battery system of claim 11, wherein each of the battery management apparatuses further comprises a temperature sensor configured to sense a temperature of the connection element.

16. The battery system of claim 11, wherein each of the first contact member and the second contact member comprises a biasing member.

17. The battery system of claim 11, wherein the board is configured to pass-through electrodes and a vent of the battery cell.

18. A battery management system, comprising:
slave battery management apparatuses;
a master battery management apparatus configured to communicate with the slave battery management apparatuses; and
a battery cell corresponding to each of the slave battery management apparatuses, and each of the slave battery management cells comprising:
a first contact member located on one side of a board;
a second contact member located on another side of a board; and
a processor configured to collect sensing data of a corresponding battery cell through the first contact member and the second contact member,
wherein the first contact member and the second contact member are configured to contact a connection element connected to the corresponding battery cell.

19. The battery pack of claim 18, wherein the first contact member is configured to contact a first connection element connected to a positive electrode of the corresponding battery cell and
the second contact member is configured to contact a second connection element connected to a negative electrode of the corresponding battery cell.

20. The battery pack of claim 18, wherein the connection element comprises:
a first busbar connected to a positive electrode of the corresponding battery cell; and
a second busbar connected to a negative electrode of the corresponding battery cell.

21. The battery pack of claim 20, wherein the first contact member is located adjacent an area corresponding to one of electrodes of the corresponding battery cell on the board and
the second contact member is located adjacent an area corresponding to another one of the electrodes of the corresponding battery cell on the board.

22. The battery pack of claim 20, wherein each of the slave battery management apparatuses further comprises a temperature sensor configured to sense a temperature of the connection element.

23. The battery pack of claim 18, wherein each of the first contact member and the second contact member comprises a biasing member.
